(19) United States
(12) Patent Application Publication
(10) Pub. No.: US 2003/0084880 A1
(43) Pub. Date: May 8, 2003

(54) Pressure-resistant common rail

(76) Inventors: Friedrich Boecking, Stuttgart (DE); Steffen Jung, Leonberg (DE); Kurt Frank, Schorndorf (DE)

Correspondence Address: KENYON & KENYON, ONE BROADWAY, NEW YORK, NY, 10004, US

(21) Appl. No.: 10/188,240

(22) Filed: Jul. 2, 2002

(30) Foreign Application Priority Data
Jul. 4, 2001 (JP) 101 32 245.3

(51) Int. Cl. F02M 1/00

(52) U.S. Cl. 123/456; 123/447

(57) ABSTRACT

The invention is directed to a high-pressure fuel storage device of a common rail fuel injection system supplying fuel to an internal combustion engine. The high-pressure fuel storage device includes a tubular base body (1), whose delimiting wall (19) encloses a lengthwise cavity (2). Several connections (8, 9, 10) for connecting high-pressure fuel lines are provided on tubular base body (1). The connections (8, 9, 10) for high-pressure fuel lines are situated decoupled from the tubular base body (1).

### TECHNICAL AREA

Fuel injection systems which include a common rail are in increasing use today in internal combustion engines. In the common rail, which is acted upon by an extremely high pressure level via a high-pressure source, the fuel volume is stored with which the individual fuel injectors, assigned to the combustion chambers of an internal combustion engine, are supplied with fuel in an almost pressure-pulsation-free manner. Extremely high pressures occur in the common rails during operation; therefore, very high demands are made on high-pressure resistance.

### BACKGROUND INFORMATION

A high-pressure fuel storage device of a common rail fuel injection system of an internal combustion engine is known from German Patent Application 195 48 611 A1. This storage device includes a tubular base body which has a pocket hole bore, running lengthwise, and several connections attached thereto. In common rail injection systems, a high-pressure pump, potentially with the help of a presupply pump, conveys the fuel to be injected from a tank to a central high-pressure fuel storage device, generally known as a common rail. Individual fuel lines run from the rail to the individual injectors, which are assigned to the engine cylinders. The injectors are activated by the engine electronics as a function of the operating parameters of the engine, in order to inject fuel into the combustion chamber of the engine. Due to the high-pressure fuel storage device, pressure generation and injection are decoupled from one another. Very high pressures occur in the high-pressure fuel storage device, thus very high demands are made on the high-pressure resistance of the high-pressure fuel storage device.

German Patent Application 199 36 533 A1 also describes a high-pressure fuel storage device. This storage device includes a tubular base body, which has a pocket hole bore, running lengthwise, the bore having several connections branching out therefrom. A stopper is situated in the closed end of the pocket hole bore. The pocket hole bore, at its closed end, has a smaller diameter than in the pocket hole bore section used for the intake of the fuel.

In the area of connections for high-pressure fuel lines, which lead to the individual fuel injectors of the engine, there are transversal holes, at which material accumulates, causing a deformation obstruction of the wall face of the common rail. The deformation obstruction in the area of the connections for the high-pressure fuel lines results in an increased stress load of the wall delimiting the common rail. This, however, limits the internal pressure load of a common rail of such a type. However, the trends in the area of development of fuel injection systems point in the direction of ever higher fuel pressure levels.

### DESCRIPTION OF THE PRESENT INVENTION

The advantages of the present invention lie primarily in the fact that a material accumulation, obstructing the deformation of the delimiting wall in the area of inevitably necessary high-pressure fuel line connections, is prevented by applying an undercut between the connecting thread and the outside of the wall delimiting the common rail. Thus, the forged, solid areas of the connecting threads are to the greatest possible extent decoupled from the rail tube, so that the tubularly configured common rail may deform unhindered. The stress level in the area of the connecting fuel lines subject to fatigue fracture may be held low, so that a potential of the common rail to increase the internal pressure is available, which in principle allows a further pressure increase in the tubularly configured common rail.

The undercut between the connecting thread and the outside of the delimiting wall may be designed to be circumferential. In addition, the undercut may only be applied locally via two milling points facing one another below the end of the connecting thread. The undercut may be formed as a forged piece during manufacture of the common rail; but it may also be formed during subsequent mechanical metal cutting operation of the component.

The diameter, in which the undercut may be formed, is only defined by the internal pressure of the component, and may support a stress to the limit given by the elastic deformation, because there is no increased stress due to discontinuities in the component geometry.

Instead of having an undercut between the connecting thread and the outside of the delimiting wall of the common rail, the connecting thread may also be received by a tubular section distant from the common rail and thus being decoupled from the common rail.

### DRAWING

The present invention is described in greater detail below on the basis of the drawing.

FIG. 1 shows a known embodiment of a common rail having a stress increasing material accumulation at the connecting thread of a high-pressure fuel line,

FIG. 2 shows a circumferential undercut between the connecting thread and the outside of the common rail,

FIG. 3 shows a local undercut, formed by two milling points opposite one another,

FIG. 4 shows the decoupling of a connecting thread of a high-pressure line from the common rail by insertion of a tubular section.

### VARIANTS OF AN EMBODIMENT

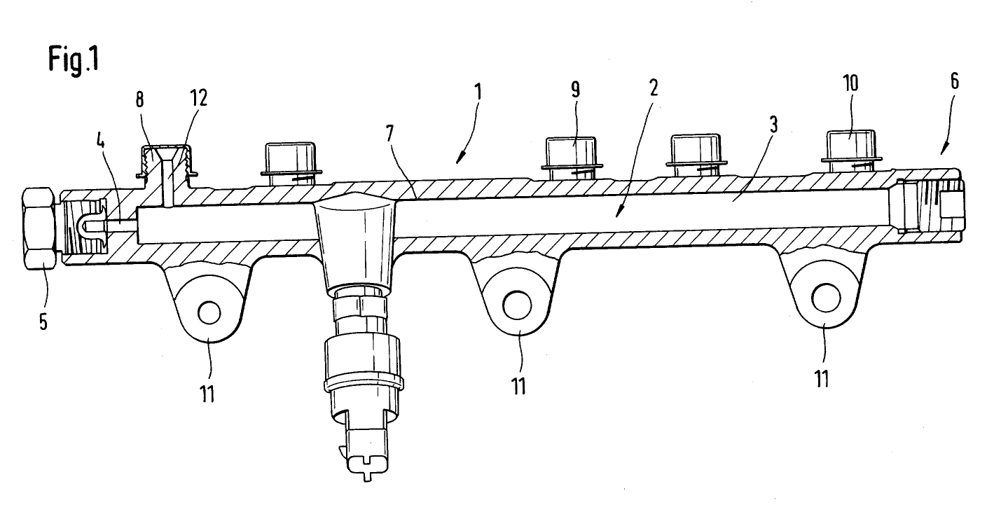

FIG. 1 shows a known embodiment of a common rail having a stress increasing material accumulation at the connecting thread of a high-pressure fuel line.

The high-pressure fuel storage device of a fuel injection system includes a tubularly designed base body, which confines cavity 2 in the form of a pocket hole bore, which essentially extends lengthwise. The pocket hole bore, forming the cavity inside of tubular base body 1, is designed to have a larger diameter in section 3 and a smaller diameter in a section 4. The section of tubular base body 1, having the smaller diameter, is provided with stopper 5, which in the embodiment according to FIG. 1 is designed as a stopper having a threaded section.

On tubular base body 1, opposite the stopper, an open end 6 is formed which in turn has a female thread to which the connecting line for a high-pressure source (not shown), for example a high-pressure pump, optionally with the help of a presupply pump, may be connected.

Section 3, having the larger diameter of tubular base body 1, forms an inside wall 7 facing cavity 2, the inside wall being penetrated, on one side of tubular base body 1, by transversal holes 12 for several high-pressure fuel line connections 8, 9, and 10. In the area of the openings of bores 12 of individual connections 8, 9, and 10 for the high-pressure fuel lines to the fuel injectors which supply fuel to the combustion chambers of the engine, a risk of fracture has been identified as being internal-pressure-limiting due to a high stress level; the risk of fracture is caused by the material accumulation below the threaded sections of connections 8, 9, and 10 (not shown) and the delimiting wall of tubular base body 1. On the opposite side of connections 8, 9, and 10 of the high-pressure fuel lines, mounting elements 11 are provided on tubular base body 1, for mounting on the internal combustion engine.

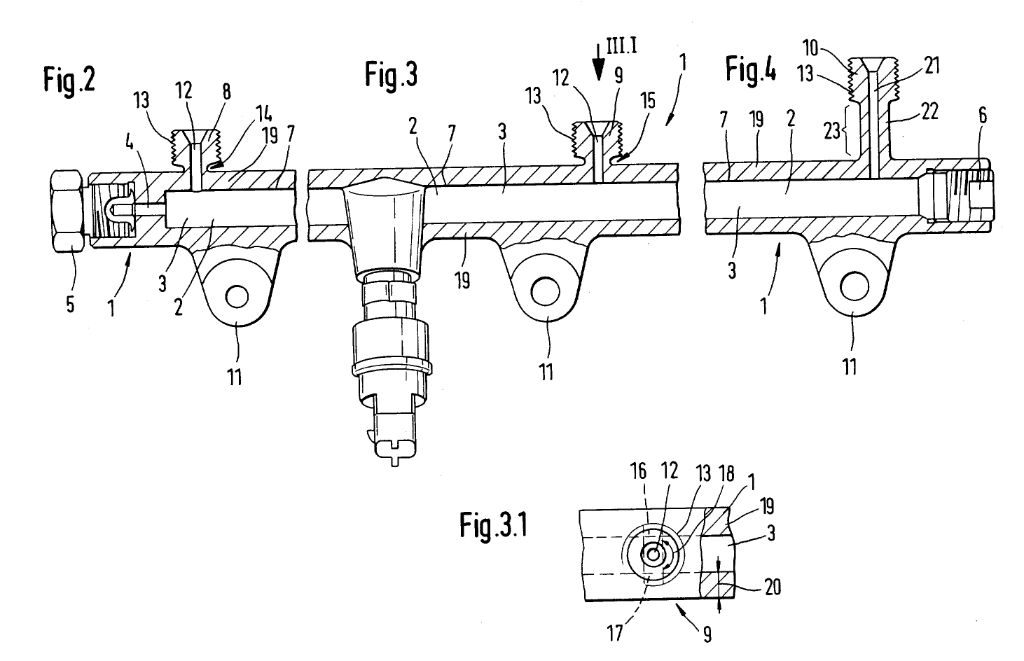

FIG. 2 shows a circumferential undercut between the connecting thread and the outside of the common rail.

Tubular base body 1, illustrated in FIG. 2 only by its end section, is provided with a connection 8 for a high-pressure fuel line, the connection being penetrated by a bore 12. Bore 12 opens into section 3, having the larger diameter of tubular base body 1. Connection 8 for the high-pressure fuel line has a male thread 13, to which the high-pressure line to the fuel injector (not shown here) may be connected in the form of a union nut, for example.

A circumferential undercut 14 is formed between the outside of delimiting wall 19 of tubular base body 1 and the thread runout of male thread 13, as shown in FIG. 2 of the embodiment according to the present invention. Due to circumferential undercut 14, the solid, forged area of connection 8 is decoupled from delimiting wall 19 of tubular base body 1 serving as the common rail. This measure establishes more favorable stress characteristics around hole 12 of connection 8, which opens into section 3, having the larger diameter of tubular base body 1. Thus fatigue fracture in the transitional area between the delimiting wall and connection 8 for a high-pressure line may be prevented, and more favorable stress characteristics may be achieved; this measure also achieves that the cavity of tubular base body 1, formed by a pocket hole bore 2, may be subjected to a higher internal pressure over a longer period of time. Section 4 of tubular base body 1, joining section 3 having the larger diameter, is outwardly sealed by seal 5, which is configured as a threaded plug, for example.

FIG. 3 shows a further embodiment of a decoupling between the connection and the common rail wall via an undercut formed by two milling points positioned opposite one another.

The illustration according to FIG. 3 shows the middle section of a tubular base body 1 in more detail. The cavity of tubular base body 1, formed by pocket hole bore 2, has an enlarged diameter in the area of the opening of transversal hole 12 of connection 9. Hole 12 opens on interior side 7 of delimiting wall 19 of tubular base body 1. According to this embodiment of the present invention, a local undercut 15 is situated between connection 9, which is also provided with a male thread 13 for the connection of a high-pressure fuel line, and the outside of delimiting wall 19. For the sake of completeness it should be noted that tubular base body 1 may have several mounting elements 11 over its length, with which tubular base body 1, serving as a common rail, is mounted in the cylinder head area of an internal combustion engine.

The illustration according to FIG. 3.1 shows a top view of the connection for a high-pressure fuel line shown in FIG. 3.

Below male thread 13 of connection 9, indicated in FIG. 3, two milling points 16 and 17, located opposite one another, are situated below the thread runout of male thread 13. According to FIG. 3.1, milling point 16 and another milling point 17 are situated displaced with respect to one another by 180°; it is also possible to configure milling points 16 and 17, which represent a material removal, in a star-shaped form, i.e., to place them at a 120° angle to one another below male thread 13. A further possibility exists in the fact that material removals 16 and 17 may be positioned displaced with respect to one another by 90° below the thread runout of male thread 13 at connection 9 for the high-pressure line. According to FIG. 3.1, material removals having reference symbols 16 and 17 are milling points; instead of milling points, recesses in the form of material removals below male thread 13 at connection 9 for the high-pressure line may also be created by other metal cutting processes. It is also conceivable to produce the undercuts directly during production of tubular base body 1 designed as a forged piece. In the illustration according to FIG. 3.1, material removal 16 and further material removal 17 are positioned, displaced 180° to one another, exactly perpendicular to delimiting walls 19 of tubular base body 1. The wall thickness of delimiting wall 19 of tubular base body 1, serving as a common rail, is indicated by reference symbol 20.

FIG. 4, in a further embodiment, shows the decoupling of a connection of the common rail from the male thread by insertion of a tubular section.

According to the illustration in FIG. 4, a connection 10 is situated at a distance, formed by length 23 of tubular section 22, from the outside of tubular base body 1. For this purpose, connection 10, at male thread 13 for the connection of a high-pressure fuel line, and tubular section 22, as well as delimiting walls 19 of tubular base body 1, are penetrated by a longer bore 21. This embodiment is extended to a tubular section 22, in contrast to the undercuts in FIG. 2 and FIG. 3, designed as circumferential undercut 14, and local undercut 15, respectively. The diameter of the undercut, i.e., the outer diameter of tubular section 22, is only defined by the interior pressure in cavity 2 of tubular base body 1, and may be selected so that the component may be subjected to stresses up to the limit of elastic deformation, because stress increases due to discontinuous geometries cannot occur.

According to the present invention, the proposed decoupling of connections 8, 9, and 10 from wall 19 of tubular base body 1, serving as a common rail, prevents a material accumulation in the transitional area from male thread 13 of connections 8, 9, and 10 to the outside of delimiting wall 19 of tubular base body 1. Thereby a more favorable stress level develops in the transitional area between connections 8, 9, and 10 and delimiting wall 19 of tubular base body 1, because a deformation hindrance due to material accumulation is henceforth impossible. An unhindered deformation of tubular base body 1 is made possible by acting upon its cavity, formed as pocket hole bore 2, so that the cavity may be subjected to a higher interior pressure load without the occurrence of fatigue fractures during the lifetime of tubular base body 1, operating as a common rail in a fuel injection system.

What is claimed is:

1. A high-pressure fuel storage device for an internal combustion engine having a fuel supply using a common rail fuel injection system, comprising a tubular base body (1), whose delimiting wall (19) encloses a lengthwise cavity (2) and includes several connections (8, 9, 10) for high-pressure fuel lines,
wherein the connections (8, 9, 10) for the high-pressure fuel lines are situated decoupled from tubular base body (1).

2. The high-pressure fuel storage device as recited in claim 1,
wherein an undercut is formed between each of the connections (8, 9, 10) and the outside of the tubular base body (1).

3. The high-pressure fuel storage device as recited in claim 2,
wherein the undercut is designed as a circumferential undercut (14).

4. The high-pressure fuel storage device as recited in claim 2,
wherein the undercut is designed as a local undercut (15).

5. The high-pressure fuel storage device as recited in claim 4,
wherein the local undercut (15) includes at least two material removals (16, 17) below a thread runout of a connecting thread (13) on the respective connection (8, 9, 10).

6. The high-pressure fuel storage device as recited in claim 5,
wherein the material removals (16, 17) are designed displaced with respect to one another 180° in one orientation (18).

7. The high-pressure fuel storage device as recited in claim 5,
wherein the material removals (16, 17) are designed displaced 120° with respect to one another.

8. The high-pressure fuel storage device as recited in claim 5,
wherein the material removals (16, 17) are designed displaced 90° with respect to one another.

9. The high-pressure fuel storage device as recited in claim 1,
wherein the connections (8, 9, 10) are decoupled from the delimiting wall (19) of the tubular base body (1) by a tubular section (22).

10. The high-pressure fuel storage device as recited in claim 9,
wherein a bore (21) in connection (10) is extended by the length (23) of tubular section (22).
